(19) United States
(12) Patent Application Publication
(10) Pub. No.: US 2007/0046987 A1
(43) Pub. Date: Mar. 1, 2007

(54) Control for execution of distributed printing

(75) Inventor: Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/501,869

(22) Filed: Aug. 10, 2006

(30) Foreign Application Priority Data
Aug. 23, 2005 (JP) 2005-240834

(51) Int. Cl. G06F 3/12

(52) U.S. Cl. 358/1.15

(57) ABSTRACT

The printing controller is connectable to multiple printing apparatuses and distributes a print job to multiple destination printing apparatuses among the connected multiple printing apparatuses. The printing controller comprises a receiving module that receives the print job, an evaluation module, a selection module, and a distribution module. The evaluation module evaluates the amount of time required for printing requested by the received print job for multiple distribution methods. The selection module selects a distribution method having shortest time required for printing from among the multiple distribution methods based on the evaluation results. The distribution module distributes the received print job using the selected distribution method.

### CROSS REFERENCE TO RELATED APPLICATIONS

This application relates to and claims priority from Japanese Patent Applications No. 2005-240834, filed on Aug. 23, 2005, the entire disclosure of which is incorporated by reference.

### BACKGROUND

1. Technical Field

The present invention relates to a technology for carrying out distributed printing wherein a print job is distributed to two or more printers.

2. Description of the Related Art

A distributed printing system is known in which a printing controller connected via a network to multiple printers distributes print jobs to the multiple printers. Using this conventional technology, the printing carried out in response to a printing request for a single print job is divided among and assigned to multiple printers and the printing is executed thereby in parallel, enabling the printing of multiple copies to be completed in a short period of time.

It is desired that distributed printing as described above be executed more efficiently and in a shorter period of time in accordance with the printing requested by a print job.

### SUMMARY

An advantage of some aspects of the invention is to achieve more efficient distributed printing in response to a print job to be distributed.

A first aspect of the invention provides a printing controller that is connectable to multiple printing apparatuses and distributes a print job to multiple destination printing apparatuses among the connected multiple printing apparatuses. The printing controller pertaining to the first aspect comprises a receiving module that receives the print job, an evaluation module, a selection module, and a distribution module. The evaluation module evaluates the amount of time required for printing requested by the received print job for multiple distribution methods. The selection module selects a distribution method having shortest time required for printing from among the multiple distribution methods based on the evaluation results. The distribution module distributes the received print job using the selected distribution method.

According to the printing controller pertaining to the first aspect, because the distribution method requiring the shortest time among multiple distribution methods is selected for each print job to be distributed, distributed printing can be achieved more efficiently.

The present invention may be realized, besides the aspect of the printing controller described above, in an aspect of a printing apparatus connected to a network or an aspect of a printing system that includes multiple printing apparatuses. Furthermore, the present invention is not limited to the aspect described above, and may be realized in the aspect of a method invention such as a print control method for distributing a print job to multiple destination printing apparatuses. Moreover, the present invention may be realized in the aspect of various other aspects, such as a computer program used to construct these methods or apparatuses, a computer readable medium on which such computer program is recorded, or a data signal encoded in a carrier wave that includes such computer program.

The above and other objects, characterizing features, aspects and advantages of the invention will be clear from the description of preferred embodiments presented below along with the attached drawings.

### BRIEF DESCRIPTION OF THE DRAWINGS

FIG. 1 shows a schematic of the basic construction of a distributed printing system of an embodiment;

FIG. 2 shows a block diagram of the internal construction of the various devices included in the distributed printing system of the embodiment;

FIGS. 3A-B show conceptual drawings describing the structure of a print job;

FIG. 4 shows a schematic showing the basic concept of page distribution;

FIG. 5 shows a schematic showing the basic concept of copy distribution;

FIG. 6 shows a table including an example of the numbers of pages allocated to destination printers in page distribution;

FIG. 7 shows a table including an example of the numbers of copies allocated to destination printers in copy distribution;

FIG. 8 shows a flow chart of a processing routine of a distributed printing process;

FIG. 9 shows a flow chart of a processing routine of a destination printer specification process;

FIG. 10 shows a flow chart of a processing routine of a distribution method selection routine;

FIG. 11 shows a schematic of an example of priority information;

FIG. 12 shows a first explanatory drawing of a specific example of distribution method selection;

FIG. 13 shows a second explanatory drawing of a specific example of distribution method selection;

FIG. 14 shows an explanatory drawing of an example of a print job that includes priority information;

FIG. 15 shows an explanatory drawing of the data construction of a first print job JB1 in a second variation; and

FIG. 16 shows a flow chart of a processing routine of a distributed printing process in the second variation.

### DETAILED DESCRIPTION OF THE PREFERRED EMBODIMENTS

Embodiments of the present invention will be described below with reference to the drawings.

A. Embodiment:

Construction of distributed printing system:

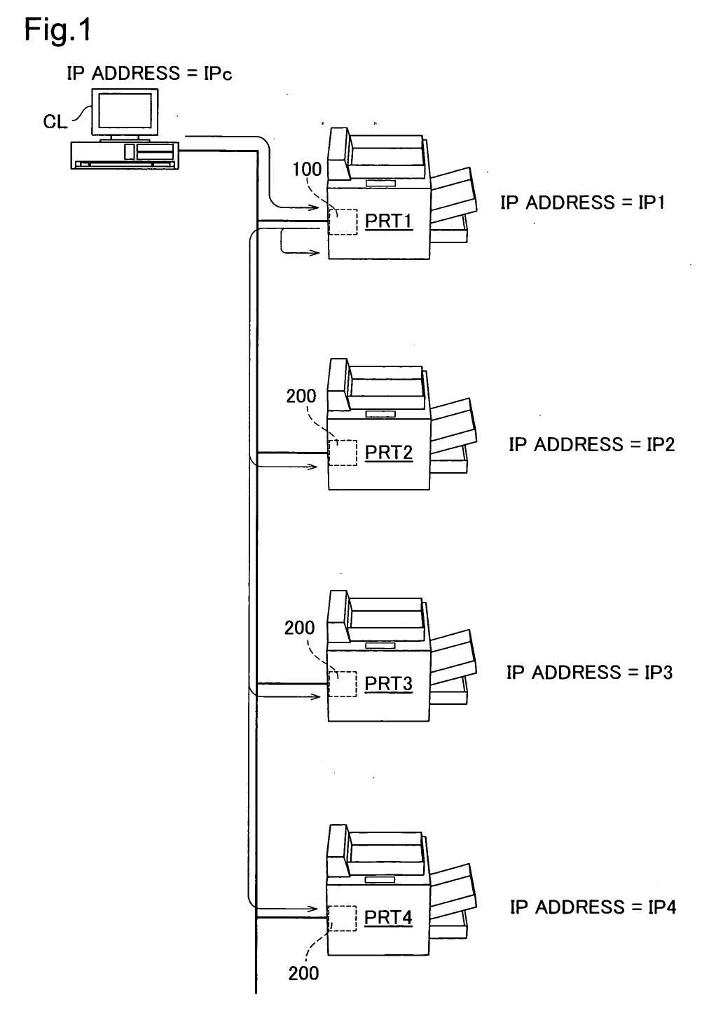

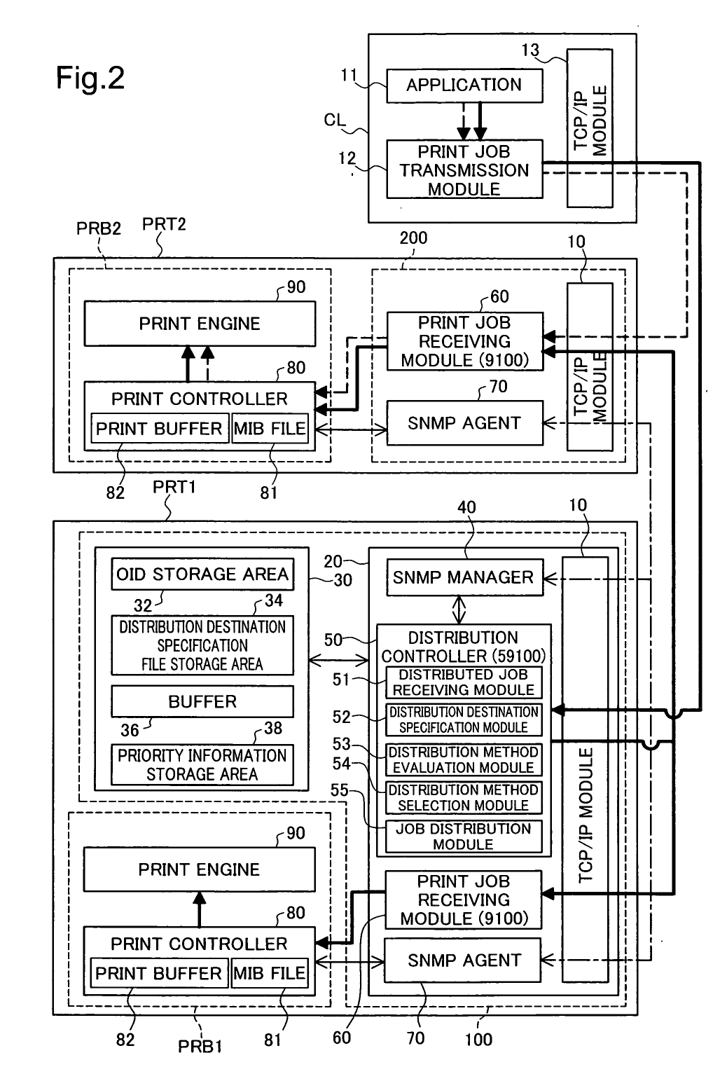

The construction of a distributed printing system pertaining to an embodiment of the invention will now be described with reference to FIGS. 1 and 2. FIG. 1 shows a schematic of the basic construction of a distributed printing system of the embodiment. FIG. 2 shows a block diagram of the internal construction of the various devices included in the distributed printing system of the embodiment.

This distributed printing system includes a computer CL (referred to below as simply a ‘client’) that serves as a client and multiple printers PRT1-PRT4, as shown in FIG. 1. The client CL and the printers PRT1-PRT4 are interconnected over a local area network (LAN). Because communication among the various devices is carried out using the TCP/IP protocol, an IP address is assigned to each device. For ease of explanation, the IP address of ‘Pc’ is set in the client CL, and the IP addresses of ‘IP1’-‘IP4’ are set in the printers PRT1-PRT4. Strictly speaking, these IP addresses are not set for the client CL and the printers PRT1-PRT4 themselves, but rather are set for nodes recognized from the viewpoint of the TCP/IP network (i.e., specifically, for network boards connected to the network in order to carry out TCP/IP communication).

A custom network board 100 is installed in the printer PRT1 among these printers. This custom network board 100 includes a distributed printing control function by which printing of a print job received from the client CL is distributed to printers PRT1-PRT4 for execution, and, in this embodiment, corresponds to the printing controller described in the Claims. A normal network board 200 is installed in the printers PRT2-PRT4.

In FIG. 1, the solid arrows indicate the sequence of operations wherein a print job is received by the custom network board 100 of the printer PRT1 from the client CL and that print job is distributed from the custom network board 100 of the printer PRT1 to the printers PRT1-PRT4. In this way, any of the printers PRT1-PRT4 can comprise a distribution destination for distributed printing from the custom network board 100 of the printer PRT1. In the discussion below, where there is no need to distinguish among the printers PRT1-PRT4, the number identifying the printer will be omitted and the symbol ‘PRT’ will simply be used. Furthermore, when a particular printer among the printers PRT1-PRT4 is deemed a distribution destination, it will be termed a destination printer.

The printer PRT1 includes a printer body PRB1 and the custom network board 100 described above, as shown in FIG. 2. The printer body PRB1 includes mainly a print engine 90 and a print controller 80. The print engine 90 performs the actual printing. The print controller 80 receives a print job supplied from the print job receiving module 60 described below, interprets the print job and controls the print engine 90 to cause it to execute printing. The print controller 80 includes a print buffer 82 that temporarily stores data including supplied print jobs. The print controller 80 stores a file (hereinafter termed a ‘MIB file’) 81 in which various information pertaining to the printer body PRB1 is collected and saved in a format called MIB (Management Information Base). Various types of information are stored in the MIB file 81 in units termed ‘objects’, and an object ID (hereinafter ‘OID’) is assigned to each object.

The custom network board 100 includes mainly a central processing unit (CPU) 20 and a memory 30. The custom network board 100 also includes a communication interface to enable actual network communication, but this communication interface is omitted from the drawing for the sake of convenience.

The function blocks realized via the CPU 20 include a TCP/IP module 10, a distribution controller 50, a print job receiving module 60, an SNMP manager 40 and an SNMP agent 70.

The TCP/IP module 10 interprets the TCP/IP protocol and executes external communication mainly over the network. Two protocols execute transport layer processing in the TCP/IP protocol: TCP (Transmission Control Protocol) and UDP (User Datagram Protocol). TCP is a protocol that implements communication where the connection is highly reliable. UDP, on the other hand, is a protocol that implements high-speed connection-less communication. The TCP/IP module 10 executes the communication of a print job described below using TCP, and also executes communication between the SNMP manager 40 and the SNMP agent 70 described below using UDP.

The distribution controller 50 receives a print job for which distributed printing is specified (hereinafter referred to as a ‘first print job’) and distributes the print job to destination printers. The distribution controller 50 can distribute a print job using two methods, as described below. The distribution controller 50 includes as sub-function blocks a distributed job receiving module 51, a distribution destination specification module 52, a distribution method evaluation module 53, a distribution method selection module 54 and a job distribution module 55. The distributed job receiving module 51 receives the first print job over the network from the client CL or other external device. The distribution destination specification module 52 specifies multiple printers that will comprise distribution destinations for the first print job from among the multiple printers connected to the custom network board 100. The distribution method evaluation module 53 evaluates the amount of time required to execute the printing requested by the first print job for each of the two distribution methods. The specific contents of this evaluation will be described below. The distribution method selection module 54 selects the distribution method with the shortest amount of required time as described above from among the two distribution methods based on the results of the evaluation performed by the distribution method evaluation module 53. The job distribution module 55 distributes the first print job using the distribution method selected by the distribution method selection module 54. The distribution of the first print job is executed by transmitting to each destination printer print jobs requesting printing that are allocated to each destination printer (hereinafter ‘second print jobs’). The processing executes by the distribution controller 50 as described above is explained below.

The print job receiving module 60 receives normal print jobs that are not specified for distribution printing, such as the second print jobs described above, for example, and supplies them to the print controller 80. The SNMP manager 40 obtains various types of information based on inquiry made to the SNMP agent 70 included in each printer PRT1-PRT4 using a communication protocol called SNMP (Simple Network Management Protocol). The SNMP manager 40 performs this inquiry by identifying the information to be obtained by specifying the OID described above.

The SNMP agent 70 obtains the desired information from the above-described MIB file in response to the inquiry from the SNMP manager 40 and transmits this information to the SNMP manager 40.

Meanwhile, in addition to storing a program to implement these various functions, the memory 30 includes an OID storage area 32, a distribution destination specification file storage area 34, a buffer 36 and a priority information storage area 38. The OID storage area 32 stores the OID specified when the above inquiry is made by the SNMP manager 40. The OID is associated upon storage with the types of information about which an inquiry may be made, and the SNMP manager 40 can obtain the OID) to be specified with reference to the OID storage area 32. The distribution destination specification file storage area 34 stores a distribution destination specification file. This distribution destination specification file is used where it is desired to specify beforehand those printers to be used during distributed printing as distribution destinations from among the multiple printers connected to the LAN. Therefore, where there is no need to specify printers in advance, the distribution destination specification file storage area 34 need not store any information. The buffer 36 is a storage area in which the CPU 20 temporarily stores data such as the received first print job. The priority information storage area 38 is an area that stores priority information used to specify the distribution method among the two distribution methods that is to be given priority. This priority information will be described below.

The printers PRT2-PRT4 each have the identical construction, and therefore only the construction of the printer PRT2 will be discussed here. The printer PRT2 includes a printer body PRB2 and the normal network board 200 described above, as shown in FIG. 2. Because the construction of the printer body PRB2 is identical to that of the printer body PRB1 of the printer PRT1 described above, the same symbols assigned to the constituent elements of the printer body PRB1 of the printer PRT1 will be assigned here as well, and further description of the printer body PRB2 will be omitted. The normal network board 200 has the same functions as the custom network board 100 described above except for the distributed printing control function. In other words, the normal network board 200 has a TCP/IP module 10, a print job receiving module 60 and an SNMP agent 70. Because the various constituent elements of the normal network board 200 0 are identical to those of the corresponding elements of the custom network board 100, the same symbols will be assigned thereto and further description of the normal network board 200 will be omitted.

As can be understood from the above description, the custom network board 100 installed in the printer PRT1 includes all of the functions included in the normal network board 200 installed in the printers PRT2-PRT4. In addition, from the standpoint of the distribution controller 50 of the custom network board 100, the printers PRT1-PRT4 are all equal, and all can be specified as destination printers during the distributed printing process described below. The distribution controller 50 can also treat the very printer PRT1 in which the distribution controller 50 is installed as equal to the other printers without distinguishing therebetween.

The client CL includes in addition to an application 11, a TCP/IP module 13 and a print job transmission module 12 as function blocks, as shown in FIG. 2. The TCP/IP module 13 has the same functions and construction as the TCP/IP module 10 of the custom network board 100 described above. The print job transmission module 12 generates a print job in response to a print request from the application 11 and sends the generated print job to a printer PRT via the TCP/IP module 13. First print jobs for which distributed printing is specified are sent only to the printer PRT1 that includes the custom network board 100, while normal print jobs for which distributed printing is not specified may be sent to any of the printers PRT1-PRT4.

Print Job

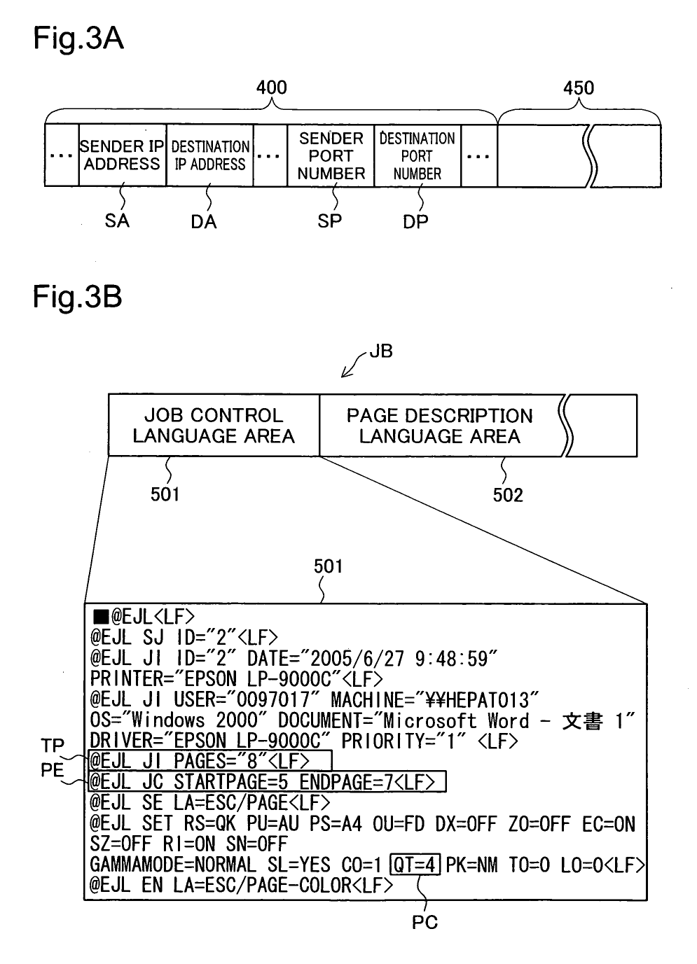

Before describing the distributed printing process, the print job used in this embodiment will be described with reference to FIGS. 3A-B. FIGS. 3A-B show conceptual drawings describing the structure of a print job. FIG. 3A shows the structure of communication data used for the communication of a print job. FIG. 3B shows the data construction of a print job.

A print job is transmitted as communication data in a format based on the TCP/IP protocol. This communication data is divided into a header 400 and a data section 450, as shown in FIG. 3A. Of these, the header 400 includes a sender IP address SA that is the IP address of the device that is the sender of the communication data and a sender port number SP that is the port number that specifies the sender software in that device. The header 400 also includes a destination IP address DA that is the IP address of the device that is the destination of the communication data and a destination port number DP that is the port number that specifies the destination software in that device. The communication data transmitted from the sender device software is received by the device having the destination IP address and supplied to the software in the receiving device that is represented by the destination port number DP and that is on standby for such transmission. The data section 450 is a section in which the data comprising the object of transmission is stored, and in this embodiment, a print job is stored therein.

For example, where a first print job specified for distributed printing is transmitted by the client CL to the printer PRT1, the IP address ‘IP1’ that is the IP address of the printer PRT1 is written to the header 400 of the communication data as the destination IP address DA described above, while ‘59100’ is written to the header 400 as the destination port number DP. ‘59100’ is a port number of the distribution controller 50 that receives the first print job. In addition, ‘IPc’ and the port number of the print job transmission module 12 (the specific number is omitted) are written to the header 400 as the sender IP address SA and the sender port number SP, respectively. On the other hand, where a normal print job that is not specified for distributed printing is transmitted to the printer PRT1 by the client CL, ‘9100’ is written to the header 400 as the destination port number DP instead of the above ‘59100’. ‘9100’ is a port number of the print job receiving module 60 that receives normal print jobs. In other words, in this embodiment, the print job transmission module 12 selects whether or not to specify distributed printing by switching the value of the destination port number DP specified in the print job when the print job is transmitted. That is, a first print job for which distributed printing is specified refers to a print job received by the distribution controller 50 whose port number ‘59100’, while a normal print job for which distributed printing is not specified refers to a print job received by the print job receiving module 60 whose port number ‘9100’. The contents of the print job itself basically do not change regardless of whether it is a first print job or a normal print job.

The data structure of a print job will now be described with reference to FIG. 3B. The print job JB has a job control language area 501 and a page description language area 502, as shown in FIG. 3B. The page description language area 502 is an area in which the print data that expresses the content to be printed is described in a prescribed page description language. ESC/Page or Postscript, for example, may be used as the page description language. The attributes necessary for printing of the print data described in the page description language area 502 are written to the job control language area 501. The job control language area 501 uses a prescribed job control language, consisting of EJL (Epson Job Language) in this embodiment.

The bottom part of FIG. 3B shows a specific example of the contents described in the job control language area 501. The job control language area 501 includes as the above-described attributes, the printing paper size, the type of page description language used for writing to the page description language area 502, total number of pages information TP and number of copies information PC. The total number of pages information TP indicates the total number of pages (Q) of the print data included in the page description language area 502. In the example shown in FIG. 3B, the total number of pages (Q) is written as ‘8’ in the total number of pages information TP. The number of copies information PC indicates the number of copies QT to be printed. In the example shown in FIG. 3B, the number of copies QT is written as ‘4’ in the number of copies information PC.

The job control language area 501 can include page specification information PE. The page specification information PE is information that specifies the pages to be printed from among the total pages in the print data included in the page description language area 502. Where the job control language area 501 of the print job includes page specification information PE, the printer PRT selectively prints only the pages specified via the page specification information PE from within the print data included in the page description language area 502. The page specification information PE includes the start page number (S), and the end page number (E). In this way, either one page or multiple continuous pages are specified from the start page number (S) to the end page number (E). In the example of FIG. 3B, ‘5’ is written as the start page number (STARTPAGE) and ‘7’ is written as the end page number (ENDPAGE). Therefore, while the print job shown in FIG. 3B includes print data for the eight pages from page 1 to page 8, printing is requested for only three of these eight pages, i.e., the three pages from page 5 to page 7. On the other hand, a print job that does not include page specification information PE in the job control language area 501 is interpreted as requesting printing of all pages of the print data included in the page description language area 502.

Distribution Method

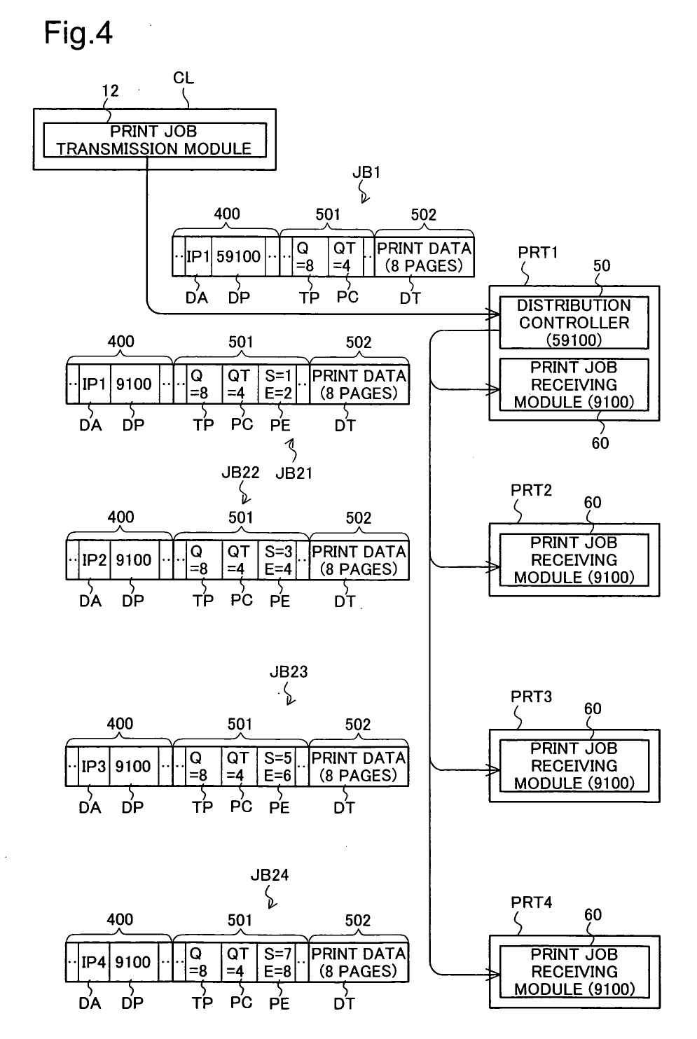

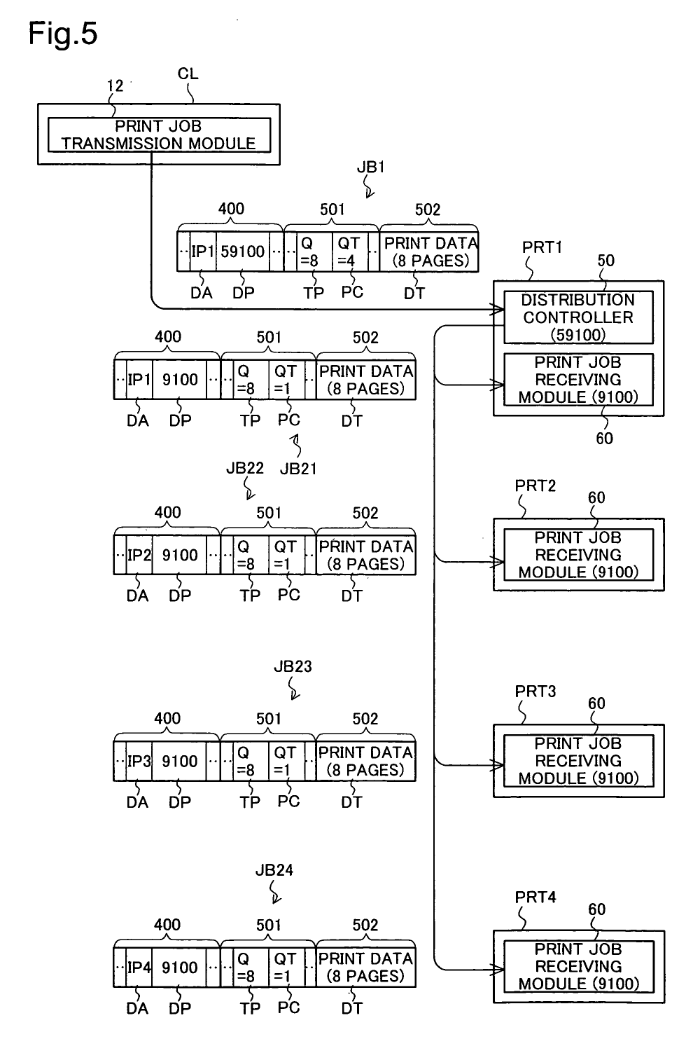

The two different distribution methods used when the distribution controller 50 of this embodiment distributes a first print job JB1 will now be described with reference to FIGS. 4 and 5. FIG. 4 shows a schematic showing the basic concept of page distribution. FIG. 5 shows a schematic showing the basic concept of copy distribution.

The two distribution methods described above are termed page distribution and copy distribution. Page distribution is a method that distributes printing of multiple pages to destination printers in page units. Copy printing is a method that distributes printing of multiple copies to destination printers in copy units. Page distribution can be used when the first print job JB1 requests printing of one or more copies of print data comprising multiple pages. On the other hand, copy printing can be used where the first print job JB1 requests printing of multiple copies of print data consisting of one or more pages. Therefore, where the first print job JB1 requests printing of multiple copies of print data extending over multiple pages, either the page distribution method or the copy distribution method may be used. The determination of which method to select in the above situation will be described below. First, specific examples of page distribution and copy distribution will be described.

In these specific examples, a first print job JB1 for which distributed printing is specified is sent from the client CL to the printer PRT1. The distribution controller 50 of the printer PRT1 receiving the first print job JB1 then distributes the printing requested by the first print job to the four printers PRT1-PRT4 as destination printers.

The first print job JB1 sent from the client CL to the printer PRT1 is sent as communication data having a header 400 in which ‘IP1’ is written as the destination IP address DA and ‘59100’ is written as the destination port number DP. In actuality, the first print job JB1 is divided into multiple TCP packets and a header 400 is added to each packet and transmitted therewith. However, in FIG. 4, in order to make the drawing more readable, the entire first print job JB1 is shown with a single header 400 attached. This convention is also followed for the second print jobs JB21-JB24 described below.

The job control language area 501 of the first print job JB1 includes the total number of pages information TP and number of copies information PC described above. In the examples shown in FIGS. 4 and 5, the total number of pages (Q) is ‘8’, while the number of copies QT is ‘4’. In other words, the first print job JB1 is requesting the printing of four copies of a document that comprises eight pages per copy. On the other hand, there is normally no need for a print job sent as the first print job JB1 to include print data that need not be printed. Therefore, in general, either the job control language area 501 does not include page specification information PE, or it includes page specification information PE that specifies all of the pages written in the total number of pages information TP. In this embodiment, the first print job JB1 does not include page specification information PE, as shown in FIGS. 4 and 5.

The print data corresponding to the total number of pages (Q) is written to the page description language area 502 of the first print job JB1 in page description language. In the example shown in FIG. 4, the eight pages of print data DT is written to the page description language area 502.

The case where this first print job JB1 is to be distributed via page distribution will first be explained (see FIG. 4). Where page distribution is used, the job distribution module 55 of the distribution controller 50 determines the pages to be allocated to each destination printer. Specifically, the job distribution module 55 determines the start page number (S) and the end page number (E) of the allocated pages for each destination printer. In the example shown in FIG. 4, each destination printer is allocated two pages, as shown below:
First destination printer (printer PRT1): S=1, E=2
Second destination printer (printer PRT2) S=3, E=4
Third destination printer (printer PRT3): S=5, E=6
Fourth destination printer (printer PRT4) S=7, E=8

The job distribution module 55 creates the second print jobs JB21-JB24 by adding to the first print job JB1 page specification information PE to specify the allocated pages determined by the job distribution module 55. Because the number of copies information PC written to the second print jobs JB21-JB24 has not changed from the corresponding information in the first print job JB1, the value of the number of copies QT is ‘4’ for each of the second print jobs. The job distribution module 55 performs distribution by transmitting the created second print jobs JB21-JB24 to the various destination printers.

Because the second print jobs JB21-JB24 are normal print jobs, ‘9100’ is written to the header 400 of the transmitted communication data for the second print jobs JB21-JB24 as the destination port number DP, as shown in FIG. 4.

The printers PRT that received the second print jobs JB21-JB24 print the specified number of copies of the allocated pages. For example, the printer PRT1 that received the second print job JB21 prints a total of eight pages, i.e., four copies of page 1 and four copies of page 2.

The case where the first print job JB1 is distributed using copy distribution will now be described (see FIG. 5). When copy distribution is used, the job distribution module 55 of the distribution controller 50 determines the number of copies to be allocated to each destination printer. In the example shown in FIG. 5, one copy is allocated to each of the first through fourth destination printers (i.e., the printers PRT1-PRT4).

The job distribution module 55 creates second print jobs JB21-JB24 by changing the value of the number of copies QT written in the number of copies information PC in the first print job JB1 to an allocated number of copies of ‘1’. Because page specification information PE is not added to the second print jobs JB21-JB24, a total of eight pages is requested for printing by each of the second print jobs JB21-JB24. The job distribution module 55 distributes the first print job JB1 by transmitting the created second print jobs JB21-JB24 to each of the destination printers, as when page distribution is performed.

Each printer PRT that received any of the second print jobs JB21-JB24 prints the specified number of copies of all pages. In the example of FIG. 5, each printer PRT prints one copy of an eight-page document.

As described above, regardless of whether the page distribution method or the copy distribution method is used, the system overall prints four copies of an eight-page document in accordance with the request of the first print job JB1.

Allocation Algorithm

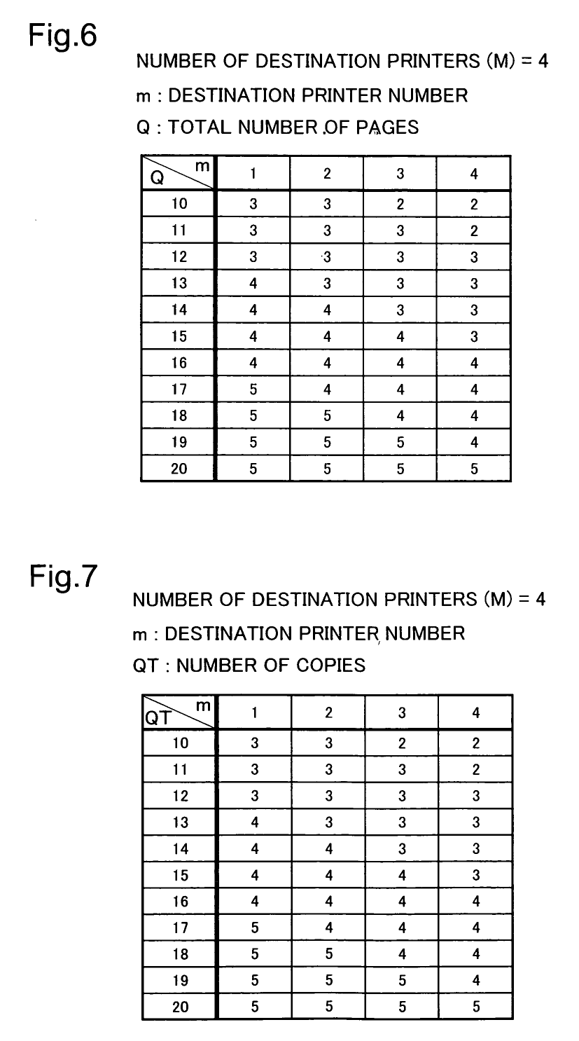

The algorithm used to determine the allocated number of pages during page distribution and the algorithm used to determine the allocated number of copies during copy distribution will now be described with reference to FIGS. 6 and 7. FIG. 6 shows a table including an example of the numbers of pages allocated to destination printers in page distribution. FIG. 7 shows a table including an example of the numbers of copies allocated to destination printers in copy distribution.

Here, the allocated number of pages during page distribution is determined based on the following two principles:
1. Allocate an equal number of pages to each destination printer to the extent possible.
2. Where a completely equal number of pages cannot be allocated, i.e., where the total number of pages (Q) for which printing is requested is not evenly divisible by the number of destination printers (M), the remaining pages are allocated one page at a time to the destination printers in the order in which the earliest pages in the page sequence were allocated.

In FIG. 6, the numbers of allocated pages sought based on the above principles where distribution is made to four destination printers are shown. In the drawing, earlier pages are allocated to the destination printers having a smaller number (m). As shown in FIG. 6, where the total number of pages (Q) for which printing is requested is evenly divisible by the number of destination printers (M), each destination printer is allocated an equal number of pages. For example, where the total number of pages (Q) is 12 and the number of destination printers is 4, each destination printer is allocated three pages. On the other hand, where the total number of pages (Q) is not evenly divisible by the number of destination printers (M), the remainder is allocated to the destination printers in the order in which the earliest pages in the page sequence were allocated. For example, where the total number of pages (Q) is 14 and the number of destination printers is 4, the two pages remaining after the total number of pages is divided by the total of four destination printers are allocated one page at a time to the two destination printers to which the earliest pages in the page sequence were allocated.

The allocated copies in copy distribution, on the other hand, are determined based on the two principles set forth below:
1. Allocate an equal number of copies to each destination printer to the extent possible.
2. Where a completely equal number of copies cannot be allocated, i.e., where the total number of copies QT for which printing is requested is not evenly divisible by the number of destination printers (M), the remaining copies are allocated one copy at a time to any of the destination printers.

FIG. 7 shows the allocated numbers of pages sought based on the above principles where a first print job JB1 is distributed among four destination printers. As one example, here the remainder is allocated with priority on destination printers having a smaller destination printer number. For example, where the number of copies QT for which printing is requested is evenly divisible by the number of destination printers (M), the same number of copies is allocated to each destination printer. However, where the number of copies QT is not evenly divisible by the number of destination printers (M), the remainder is allocated one copy at a time to the destination printers having the smaller destination printer number (m).

The specific computations performed in order to achieve the above algorithms will now be described. First, the formula used to determine the number of allocated pages during page distribution will be described. Here, the total number of pages for which printing is requested is represented by (Q), the number of destination printers is represented by (M), and the destination printer number assigned to each destination printer in the order of allocation of earlier pages in the page sequence is represented by (m). Then, P(m) that represents the number of pages allocated to the m-th destination printer is calculated using the Equation (1) below.

$$P ( m ) = Int \{ \frac{Q + ( M - m )}{M} \} \qquad ( 1 )$$

Here, the function Int(A) is a function that extracts the integer component of the numerical value (A). For example, Int(3.23) is ‘3’. If the numerical values (Q), (M) and (m) are inserted into the above numerical expression, the values in the table shown in FIG. 7 can be obtained. Using P(m), the start page number S(m) and the end page number E(m) of the allocated pages allocated to the m-th destination printer are calculated using the Equations (2) and (3) below.

$$\begin{matrix}\begin{matrix}S ( 1 ) = 1 , S ( m ) = S ( 1 ) + {\sum }_{k = 1}^{m - 1} P ( k ) & ( 2 \leq m \leq M )\end{matrix} & ( 2 ) \\ \begin{matrix}E ( m ) = {\sum }_{k = 1}^{m} P ( k ) & ( 1 \leq m \leq M )\end{matrix} & ( 3 )\end{matrix}$$

The expression used to determine the number of allocated copies during copy distribution will now be explained. Here, the total number of copies for which printing is requested is represented by QT, the number of destination printers is represented by (M), and the destination printer number assigned to each destination printer in the order of allocation of remainder pages is represented by (m). Then, C(m) that represents the number of copies allocated to the m-th destination printer is calculated using the Equation (4) in which the total number of pages Q in the above formula (1) is replaced by the number of copies QT.

$$C ( m ) = Int \{ \frac{QT + ( M - m )}{M} \} \qquad ( 4 )$$

Distributed Printing Process

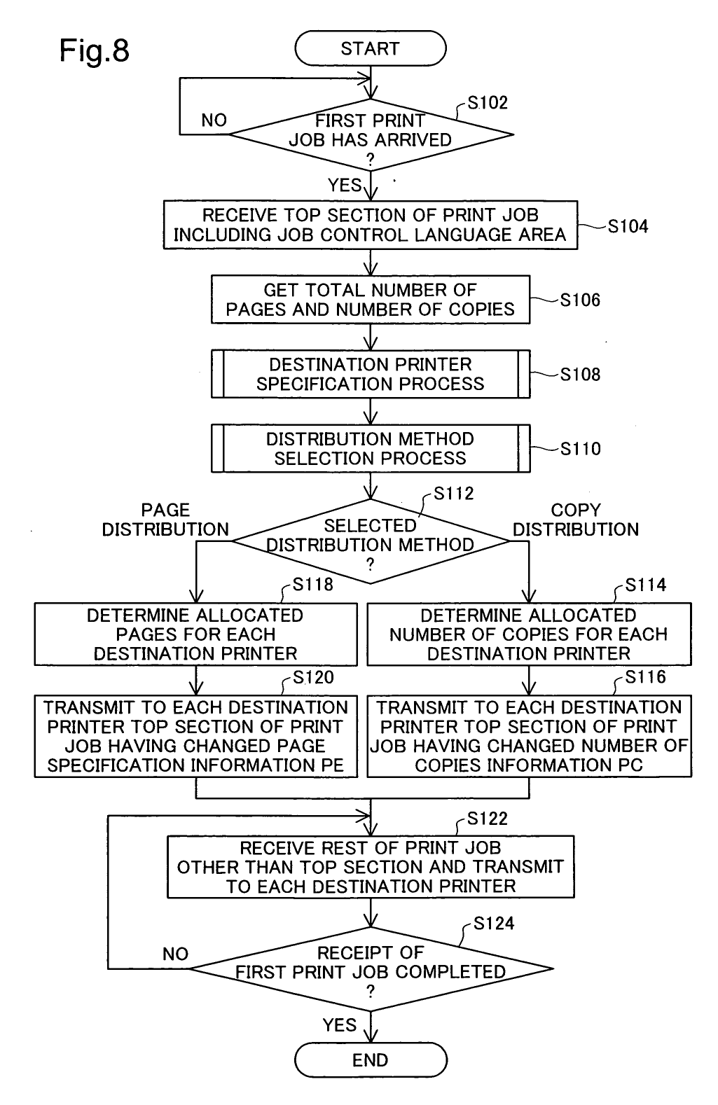

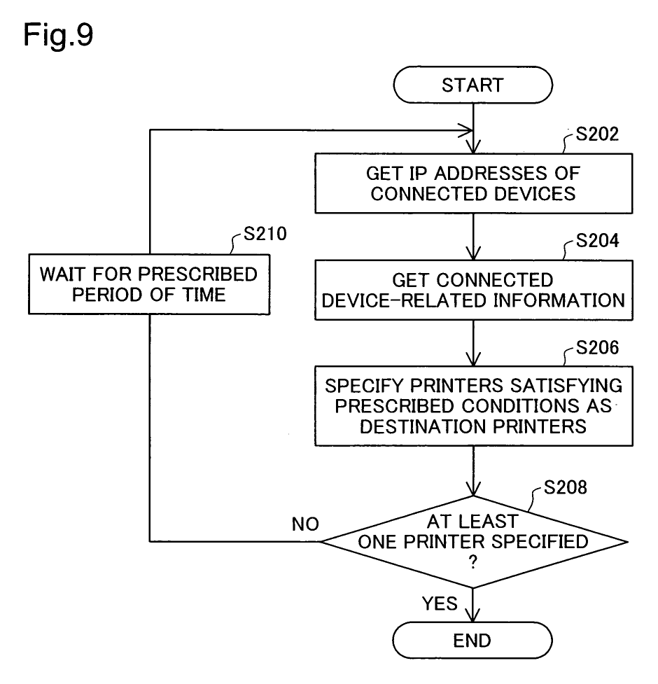

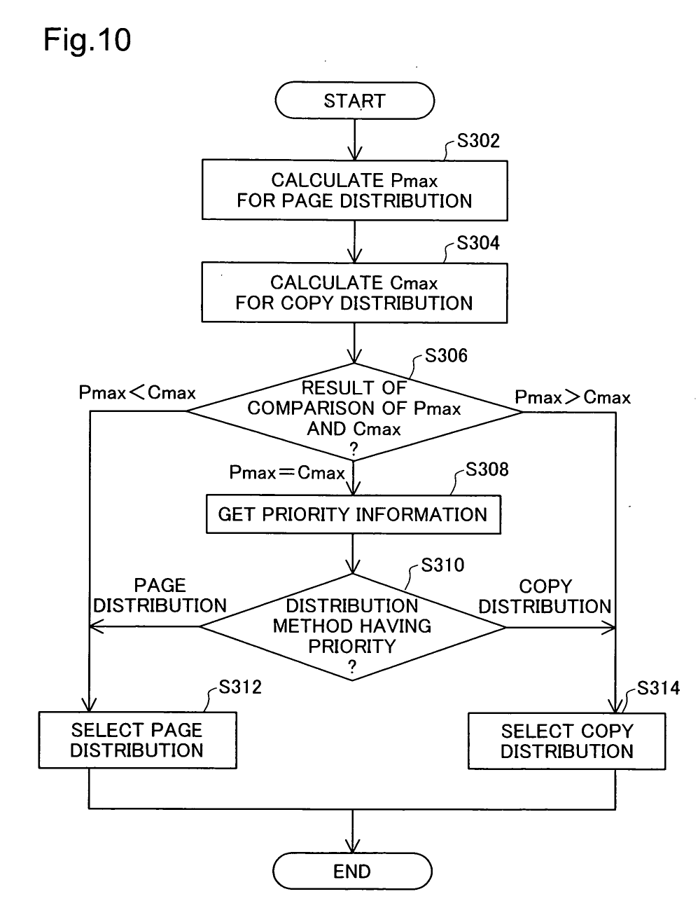

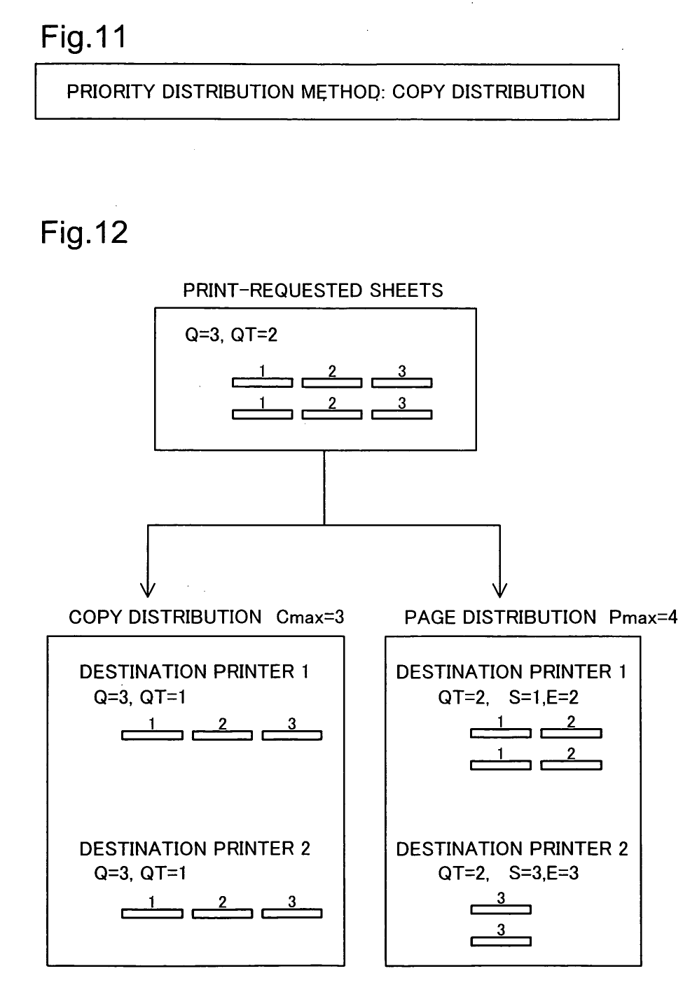

The distributed printing process executed by the distribution controller 50 will now be explained with reference to FIGS. 8-11 for both of the distribution methods described above. FIG. 8 shows a flow chart of a processing routine of a distributed printing process. FIG. 9 shows a flow chart of a processing routine of a destination printer specification process. FIG. 10 shows a flow chart of a processing routine of a distribution method selection routine. FIG. 11 shows a schematic of an example of priority information.

The distributed printing process is a process executed by the distribution controller 50 incorporated in the CPU 20 of the custom network board 100. When the printer PRT1 in which the custom network board 100 is installed is in a state in which a print job can be received, the distributed job receiving module 51 of the distribution controller 50 waits for the arrival of a first print job JB1 described above (step S102). When a first print job JB1, i.e., a print job for which the destination port number DP is ‘59100’, arrives at the printer PRT1 from the client CL (step S102: YES), the distributed job receiving module 51 receives the first print job JB1 via the TCP/IP module 10. The distributed job receiving module 51 first receives the top section of the print job including the job control language area 501 (step S104).

The distribution controller 50 obtains the total number of pages (Q) and the number of copies QT for which printing is requested via the received first print job (step S106). Specifically, the distribution controller 50 reads the job control language area 501 and obtains the total number of pages information TP and the number of copies information TP included in the first print job.

The distribution controller 50 then executes the destination printer specification process (step S108). The destination printer specification process is a process executed by the distribution destination specification module 52 of the distribution controller 50. As shown in FIG. 9, when the destination printer specification process is begun, the distribution destination specification module 52 obtains the IP addresses of the devices connected to the network (step S202). When a distribution destination specification file is stored in the distribution destination specification file storage area 34, the distribution destination specification module 52 obtains the IP addresses with reference to the distribution destination specification file. The distribution destination specification file contains the IP addresses of the printers desired for use as distribution destinations. For example, such a distribution destination specification file is stored in the printer PRT1 using a configuration computer when the default settings of the printer PRT1 are loaded. Where such a distribution destination specification file is to be used, if the printer PRT1 itself is also to be used as a distribution destination, the IP address ‘IPl’ of the printer PRT1 need also be written in the distribution destination specification file.

If a distribution destination specification file is not stored, on the other hand, the distribution destination specification module 52 asks for the IP address of each device connected to the LAN by broadcasting an inquiry command using the SNMP manager 40 and obtains the IP addresses sent in response.

Next, the distribution destination specification module 52 obtains information regarding each device to which the obtained IP addresses are allocated (step S204). Specifically, the distribution destination specification module 52 issues a unicast inquiry to each device and obtains the model name and status of each device received in response to this inquiry.

The distribution destination specification module 52 then searches for printers that satisfy prescribed conditions from among the devices connected to the network based on the received model names and status information and specifies the found printers as destination printers (step S206). Examples of such prescribed conditions are provided below.
1. The printer is the same model as the printer PRT1.
2. The power to the printer is ON.
3. The remaining toner amount exceeds a prescribed threshold value.
4. The printer is online.
5. The printer is not busy (that is, the print engine 90 is not being driven).

All of the information regarding each of these conditions can be obtained via inquiry issued by the above-described SNMP manager 40. The first condition requiring that the printer have the same model name as the printer PRT1 is imposed in order to ensure accurate printing without print job data conversion in each destination printer when distributed printing is carried out. As a result, the quality of the printed product from each destination printer can be harmonized with respect to the resolution and font, for example. In addition, consistency regarding instructions regarding color printing and two-sided printing, for example, can be ensured. The reason that the model name inquiry is issued even to devices whose IP addresses are already specified in the distribution destination specification file is discussed below. That is, such inquiry is made to confirm that the printer is the same model as the printer PRT1 because the IP addresses written in the distribution destination specification file may be allocated to printers of models different from the printer PRT1, or to non-printer devices after the distribution destination specification file is created.

The second through fifth conditions are intended to prevent selection of a printer that cannot immediately perform printing as a destination printer. ‘The printer is online’ means that the printer is not in an offline state, for example, out of paper or in an error state due to paper jam.

The distribution destination specification module 52 then determines whether or not at least one destination printers have been specified (step S208). If at least one destination printers have been specified (step S208:YES), the distribution destination specification module 52 ends the destination printer specification process. If no destination printer has been specified (step S208:NO), the distribution destination specification module 52 waits for a prescribed period of time (step S210) and the repeats the operations of steps S202-S208.

If at least one destination printer has been specified, the distribution controller 50 executes the distribution method selection process (step S110). The distribution method selection process is executed by the distribution method evaluation module 53 and distribution method selection module 54 of the distribution controller 50. When the distribution method selection process is begun, first, the distribution method evaluation module 53 calculates Pmax that is the maximum-number of printed sheets if page distribution were employed (step S302). The maximum number of printed sheets is the number of sheets to be printed by the destination printer that allocated the highest number of sheets among all destination printers. The number of sheets to be printed is the number of printing medium to be output as a result of printing allocated to a given destination printer where distributed printing is carried out using a given distribution method. The value of Pmax is calculated by the Equation (5) below.
Pmax=MAX{P(m)}×QT (5)

Here, MAX {P(m)} is the highest value of the number of pages P(m) allocated to each destination printer described above. Where the above-referenced page distribution algorithm is used, because MAX{P(m)}=P(i), Pmax=P(1)× QT results.

Next, the distribution method evaluation module 53 calculates Cmax that is the maximum number of printed sheets if copy distribution were employed (step S204). The value of Cmax is calculated by the Equation (6) below.
Cmax=MAX {C(m)}×Q (6)

Here, MAX {C(m)} is the highest value of the number of copies C(m) allocated to each destination printer described above. Where the above-referenced copy distribution algorithm is used, because MAX{C(m)}=C(1), Cmax=C(1)×Q results.

The values Pmax and Cmax calculated in steps S302 and S304 serve as evaluation values for the amount of time required to perform printing where the corresponding distribution methods are used. In this embodiment, it is ensured that all destination printers are the same printer model via the conditions used to specify the destination printers. As a result, the printing speed of each destination printer (expressed in terms of PPM, i.e., pages per minute, for example), is identical. Therefore, the amount of time required for distributed printing can be essentially determined from the number of sheets to be printed. Consequently, the amount of time required for distributed printing is determined by the number of printed sheets to be created by the destination printer that is to print the largest number of sheets.

Next, the distribution method selection module 54 compares the values for Pmax and Cmax calculated by the distribution method evaluation module 53 (step S306). If it is determined from this comparison that Pmax<Cmax, i.e., if it is determined that the amount of time for page distribution is shorter than that for the copy distribution, the distribution method selection module 54 selects page distribution as the distribution method to be used (step S312). On the other hand, if it is determined as a result of the above comparison that Pmax>Cmax, i.e., if it is determined that the amount of time for copy distribution is shorter than that for the page distribution, the distribution method selection module 54 selects copy distribution as the distribution method to be used (step S314).

If it is determined from the above comparison that Pmax=Cmax, the distribution method selection module 54 obtains priority information from the priority information storage area 38 (step S310). Priority information is information used to specify the distribution method among the distribution methods available to the distribution controller 50 to which priority will be given during selection. In this embodiment, either page distribution or copy distribution is stored in the priority information storage area 38 as priority information (in the example shown in FIG. 11, it is copy distribution). This priority information may be set by the user or set in advance at the time of product shipment. The distribution method selection module 54 selects either page distribution or copy distribution based on the obtained priority information (steps S312 and S314).

When the distribution method is selected, the distribution method selection process is ended and the distribution controller 50 returns to the flow chart shown in FIG. 8. Where the selected distribution method is the copy distribution method, the job distribution module 55 determines the allocated number of copies C(m) for each destination printer (step S114). The job distribution module 55 then transmits the top section of each second print job in which the number of copies information PC in the job control language area 501 is changed to the respective destination printer, as described with reference to FIG. 5 (step S116). If the selected distribution method is the page distribution method, on the other hand, the start page number S(m) and end page number E(m) of the pages allocated to each destination printer are determined using the Equations (2) and (3) above (step S118). The job distribution module 55 then transmits the top section of each second print job in which the page specification information PE of the job control language area 501 is changed to the respective destination printer, as described with reference to FIG. 4 (step S120).

The distributed job receiving module 51 of the distribution controller 50 then receives the sections of the first print job JB1 following the top section from the client CL and the job distribution module 55 of the distribution controller 50 transmits the received sections as is to the printers PRT1-PRT4 (step S122). The distribution controller 50 thereafter determines whether or not all of the first print job JB1 has been received (step S124). If the distribution controller 50 determines that all of the first print job JB1 has not been received (step S124:NO), it returns to step S122. If the distribution controller 50 determines that receipt of the first print job JB1 has been completed, however (step S124:YES), this process ends.

Specific examples of distribution method selection

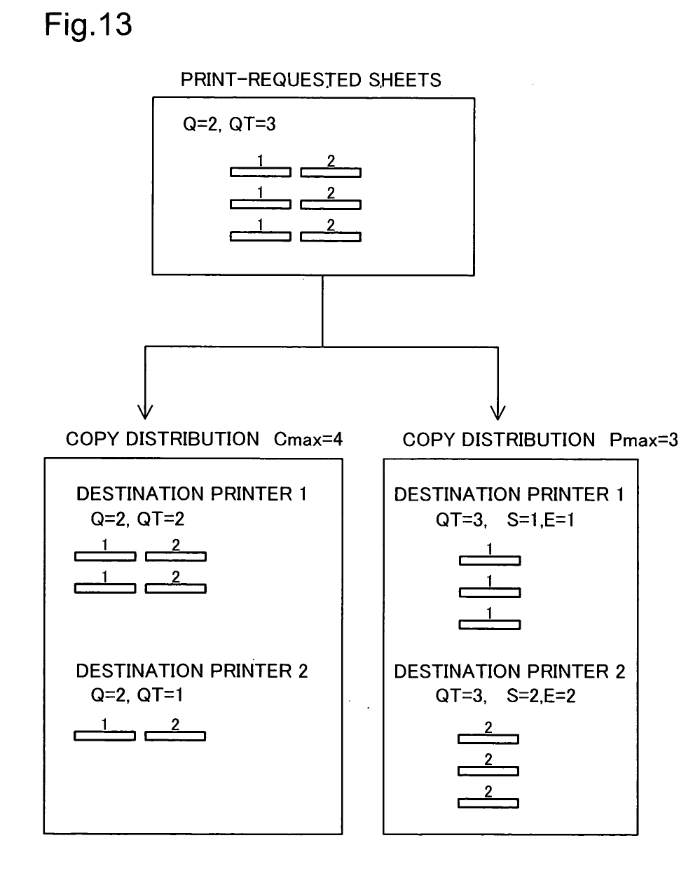

FIGS. 12 and 13 show explanatory drawings of specific examples of distribution method selection. In the distributed printing of these examples, for ease of understanding, it is assumed that a first print job JB1 is divided among two destination printers (termed the destination printer 1 and the destination printer 2).

FIG. 12 shows the case where the first print job JB1 requests printing of two copies of a three-page document (Q=3, QT=2). A situation in which the first print job JB1 is distributed using the above-described copy distribution (see FIG. 5 and Equation (4)) will be considered. In this case, one copy of pages 1-3 is distributed to each of the two destination printers, as shown in FIG. 12. Therefore, the number of sheets to be printed by each of the destination printer 1 and the destination printer 2 is 3×1=3. Thus the value of Cmax is 3.

The case where the first print job JB1 is distributed using the above-described page distribution (see FIG. 4 and Equations (2), (3)) will now be considered. In this case, two copies of pages 1 and 2 are distributed to the destination printer 1 and two copies of page 3 are distributed to the destination printer 2, as shown in FIG. 12. Therefore, the number of sheets to be printed by the destination printer 1 is 2×2 =4, while the number of sheets to be printed by the destination printer 2 is 1×2=2. Thus the value of Pmax is 4. Because Pmax>Cmax, copy distribution is selected as the distribution method according to the distributed printing process described above.

FIG. 13 shows the case where the first print job JB1 requests printing of three copies of a two-page document (Q=2, QT=3). A situation in which the first print job JB1 is distributed using the above-described copy distribution (see FIG. 5 and Equation (4)) will be considered. In this case, two copies of pages 1-2 are distributed to the destination printer 1 and one copy of pages 1-2 are distributed to the destination printer 2, as shown in FIG. 13. Therefore, the number of sheets to be printed by the destination printer 1 is 2×2=4, while the number of sheets to be printed by the destination printer 2 is 1×2=2. Thus the value of Cmax is 4.

The case where the first print job JB1 is distributed using the above-described page distribution (see FIG. 4 and Equations (2), (3)) will now be considered. In this case, three copies of page 1 are distributed to the destination printer 1 and three copies of page 2 are distributed to the destination printer 2, as shown in FIG. 13. Therefore, the number of sheets to be printed by both the destination printer 1 and the destination printer 2 is 1×3=3. Thus the value of Pmax is 3. Because Pmax<Cmax, page distribution is selected as the distribution method according to the distributed printing process described above.

According to the embodiment described above, the custom network board 100 selects the distribution method having the shorter required printing time from among the copy distribution method and the page distribution method in response to the contents of the print request contained in the first print job JB1. As a result, using the system pertaining to the embodiment, distributed printing can be carried out quickly and efficiently.

In addition, the custom network board 100 evaluates the required printing time based on the values Cmax and Pmax for the maximum number of printed sheets under each method. As a result, the amount of time required for distributed printing can be easily evaluated. In this embodiment, because each destination printer is the same model of printer and the processing speeds thereof are identical, the required printing time can be evaluated based on the number of printed sheets.

Moreover, where the maximum numbers of printed sheets Cmax and Pmax for the two distribution methods are identical, the custom network board 100 selects the distribution method based on priority information. Consequently, even where the evaluation results regarding the required printing time are equal for both methods, the preferred distribution method can be selected. Because this priority information can be set by the user, the distribution method can be selected while reflecting the user's wishes.

Furthermore, because the custom network board 100 is installed in the printer PRT1 that can be used as a destination printer, efficient distributed printing can be realized using a simple construction involving multiple printers PRT without using an external device such as a dedicated distribution server.

B. Variations

First variation

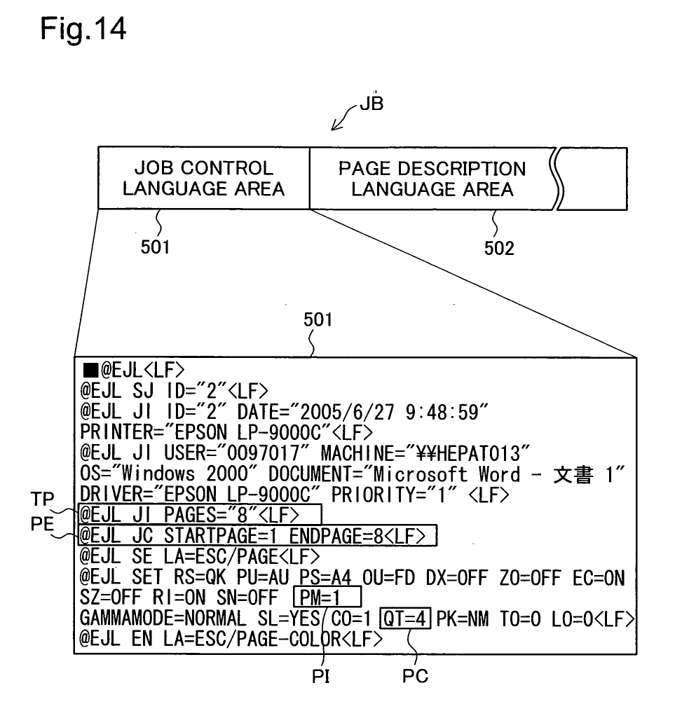

In the above embodiment, the priority information was obtained from the priority information storage area 38, but it may be obtained using a different method. For example, it is acceptable if the priority information is set for each first print job JB1 by the client CL and included in the first print job JB1. FIG. 14 shows an explanatory drawing of an example of a print job that includes priority information. The print job JB shown in FIG. 14 contains, in addition to the contents of the print job JB1 shown in FIG. 3B, priority information PI written in the job control language area 501. For example, ‘page distribution’ can be given priority if ‘PM=1’, while ‘copy distribution’ can be given priority if ‘PM=2’. Where such a print job JB is used as the first print job JB1 , the custom network board 100 can easily obtain the priority information for each first print job JB1 .

In addition, priority information may be stored as a MIB object in the custom network board 100. In this case, the priority information can be easily set using the SNMP protocol by the client CL or a computer connected to the network.

Second Variation

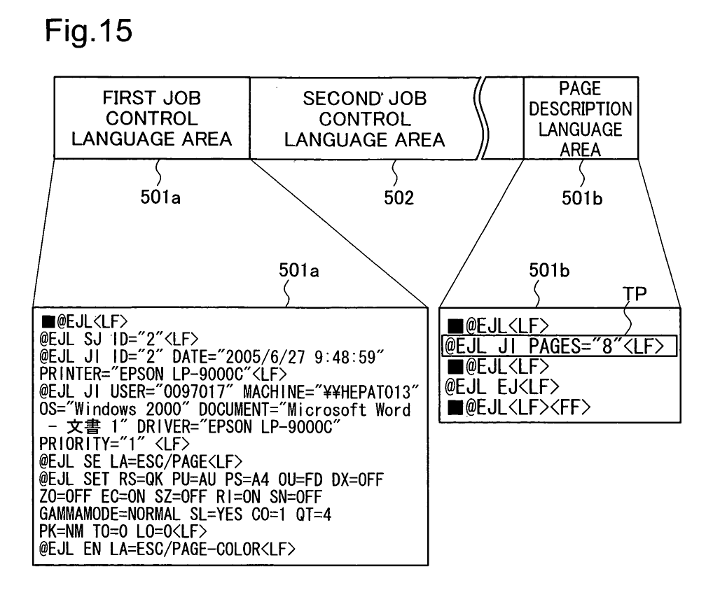

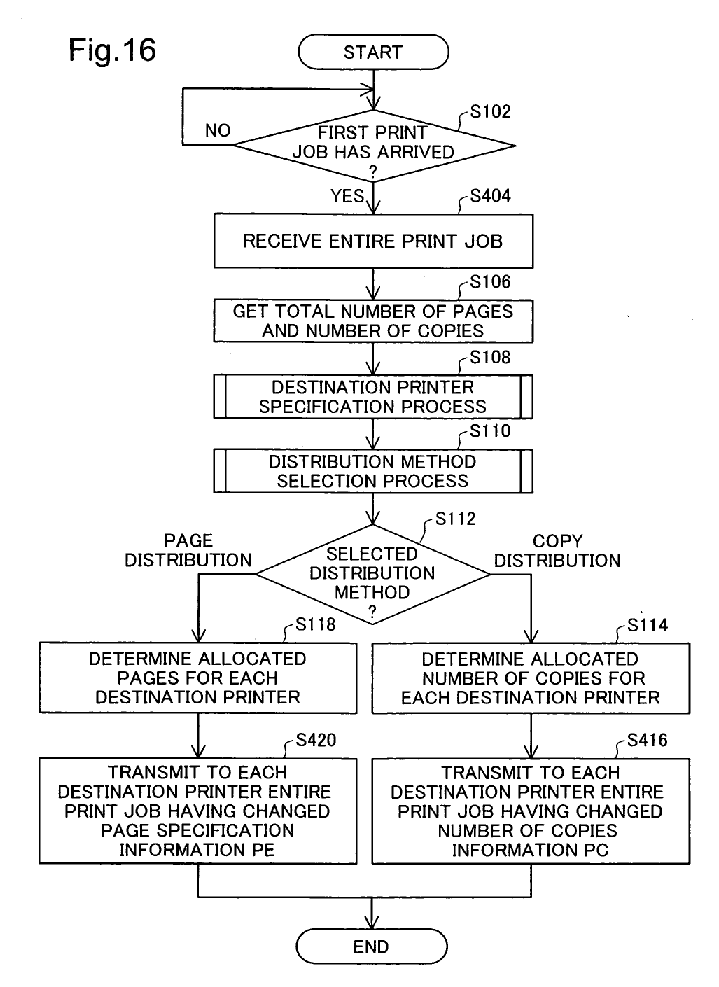

A second variation will be described with reference to FIGS. 15 and 16. FIG. 15 shows an explanatory drawing of the data construction of a first print job JB1 in a second variation. FIG. 16 shows a flow chart of a processing routine of a distributed printing process in the second variation.

In the first print job JB1 of this variation, unlike in the first print job JB1 of the embodiment, the job control language area 501 has two parts, i.e., it is divided into a first job control language area 501A and a second job control language area 501B. The first job control language area 501A is disposed before the page description language area 502, while the second job control language area 501B is disposed after the page description language area 502. In other words, when the first print job JB1 of this variation is received by the distributed job receiving module 51 of the distribution controller 50, it is received in the order of the first job control language area 501A, the page description language area 502, and the second job control language area 501B. The second job control language area 501B contains, among the information included in the job control language area 501 of the embodiment, the total number of pages information TP, while the first job control language area 501 contains other information. The first print job JB1 sometimes has this construction, depending on the specifications of the print controller 80 and the printer driver of the client CL.

The distributed printing process of this variation will now be described. The differences between this process shown in FIG. 16 and the corresponding process of the embodiment described with reference to FIG. 8 are that step S404 is executed instead of step S104 shown in FIG. 5, and steps S416 and S420 are executed instead of steps 116 and steps S120-S124.

In step S404, the distributed job receiving module 51 of the distribution controller 50 receives not just the top section of the first print job JB1 , but the entire first print job JB1 . The reason for this is that because the total number of pages Q must be obtained with reference to the total number of pages information TP in the next step S106, the distribution controller 50 must receive the second job control language area 501B, which is the last print job component to be received.

In step S416 and S420, respectively, the job distribution module 55 generates second print jobs JB21-JB24 by changing the number of copies information PC or by adding page specification information PE in the first print job JB1 , and sends the generated print jobs to the destination printers. Because the entire first print job JB1 is received in step S404, there is no need to repeat the receipt of the first print job JB1 and the transmission of the second print jobs JB21-JB24 as in the embodiment.

Because the processing is identical for the other steps in this variation and in the embodiment, the same symbols used in FIG. 8 will be used in FIG. 16, and further description will be omitted.

According to this variation, because the entire first print job JB1 must be received once, the buffer 36 must have a sufficient storage area to store the entire first print job JB1 . In all other respects, the same operation and effect of the embodiment can be obtained with this variation.

Third Variation

In the embodiment, the amount of time required for printing was evaluated using the maximum number of printed sheets values Cmax and Pmax, but it is acceptable if a characteristic related to the printing speed of the destination printers is considered. For example, where the printing speeds of the multiple destination printers differ, the required printing time may be evaluated using the printing speed of each destination printer.

In this case, the distribution method evaluation module 53 obtains the printing speed of each destination printer. For example, a table in which the printing speeds of various printer models are recorded (in units of PPM (pages per minute), for example) is stored in the memory 30 of the custom network board 100. The distribution method evaluation module 53 then obtains the printing speed PT(m) (where (m) is the number of the destination printer) from the above table based on the model names of the destination printers obtained in the above step S204. Alternatively, each destination printer may contain information specifying the printing speed PT(m) as MIB information. In this case, the distribution method evaluation module 53 can obtain the printing speed PT(m) from each destination printer via inquiry thereto using the SNMP protocol.

The distribution method evaluation module 53 then calculates the required printing time for each destination printer for both the copy distribution method and the page distribution method. For example, if the required printing time for the m-th destination printer in the case of copy distribution is deemed CNT(m) and the required printing time for the m-th destination printer in the case of page distribution is deemed PNT(m), the above calculations are carried out using the Equations (7) and (8) below.
CNT(m)=C(m)×Q/PT(m) (7)
PNT(m)=P(m)×QT/PT(m) (8)

The distribution method evaluation module 53 then calculates the maximum values MAX{CNT(m)} and MAX{PNT(m)} among the required printing times CNT(m) and PNT(m) for each destination printer. The distribution method selection module 54 compares the maximum values MAX{CNT(m)} and MAX{PNT(m)} and selects the distribution method. If MAX{CNT(m)} <MAX{PNT(m)}, the copy distribution method is selected, while if MAX{CNT(m)} >MAX{PNT(m)}, the page distribution method is selected. If MAX{CNT(m)}=MAX{PNT(m)}, the distribution method is selected based on the priority information.

In this way, because the distribution method is chosen taking into account the performance of each printer, the optimal distribution method can be selected even where the printing speeds of the various destination printers differ.

Other Variations

In place of the copy distribution and page distribution described in connection with the embodiment, or together with these distribution methods, various other different distribution methods may be used. For example, where there is no condition that each destination printer comprise the same printer model, a distribution method may be used that determines the number of allocated pages P(m) or the number of allocated copies C(m) taking into account the printing speed of each destination printer. In this case, by combining any of the various other different distribution methods with the distribution method selection that takes into consideration the printing speeds that were described above in connection with the third variation, printing can be completed more quickly and efficiently where the various destination printers have different printing speeds.

Furthermore, where the distribution controller 50 can use three or more types of distribution methods, it is acceptable if the distribution method that has the shortest required printing time is selected after evaluation of the required printing time for all distribution methods.

In the above embodiment, the various components of the printer PRT that were realized via software may be realized instead via hardware and vice versa.

Various types of devices may be used as the print engine 90 in the above embodiment. For example, it need not be based on laser technology, and may instead use inkjet technology, sublimation technology, dot-impact technology, thermal transfer technology or any other type of print engine technology.

While the print control technology pertaining to the invention have been shown and described on the basis of the embodiments and variations, the embodiments of the invention described herein are merely intended to facilitate understanding of the invention, and implies no limitation thereof. Various modifications and improvements of the invention are possible without departing from the spirit and scope thereof as recited in the appended claims, and these will naturally be included as equivalents in the invention.

1. A printing controller that is connectable to multiple printing apparatuses and distributes a print job to multiple destination printing apparatuses among the connected multiple printing apparatuses, the printing controller comprising:
a receiving module that receives the print job;
an evaluation module that evaluates the amount of time required for printing requested by the received print job for multiple distribution methods;
a selection module that selects a distribution method having shortest time required for printing from among the multiple distribution methods based on the evaluation results; and
a distribution module that distributes the received print job using the selected distribution method.

2. A printing controller according to claim 1, wherein the multiple distribution methods include a first method that distributes printing extending over multiple pages to each of the destination printing apparatuses in page units and a second method that distributes printing extending over multiple copies to each of the destination
printing apparatuses in copy units.

3. A printing controller according to claim 1, wherein the evaluation is performed using the maximum number of printed sheets allocated to each of the destination printing apparatuses.

4. A printing controller according to claim 3, wherein
the selected distribution method is a distribution method having the smallest maximum number of printed sheets among the multiple distribution methods.

5. A printing controller according to claim 1,
wherein the selection module further obtains priority information used to specify a distribution method that is to be given priority among the multiple distribution methods,
and wherein the selected distribution method is selected based on the evaluation results
and the priority information.

6. A printing controller according to claim 5, wherein
where two or more distribution methods exist for which the evaluation results are equal, the selection module selects a distribution method to which the priority is given among the two or more distribution methods.

7. A printing controller according to claim 5, wherein
the priority information is set in accordance with user instruction.

8. A printing controller according to claim 5, wherein
the priority information is included in the received print job.

9. A printing controller according to claim 3, wherein
the evaluation is performed taking into account a characteristic related to the printing speed of each of the destination printing apparatuses.

10. A printing controller according to claim 1, wherein
the device is installed in at least one of the multiple printing apparatuses.

11. A printing apparatus in which the printing controller according to claim 1 is installed.

12. A print control method of distributing a print job to multiple destination printing apparatuses, the print control method comprising:
receiving the print job;
evaluating the amount of time required for printing requested by the received print job for multiple distribution methods;
selecting a distribution method having shortest time required for printing from among the multiple distribution methods based on the evaluation results; and
distributing the received print job using the selected distribution method.

13. A print control method according to claim 12, wherein
the multiple distribution methods include a first method that distributes printing extending over multiple pages to each of the destination printing apparatuses in page units and a second method that distributes printing extending over multiple copies to each of the destination printing apparatuses in copy units.

14. A print control method according to claim 12, wherein
the evaluation is performed using the maximum number of printed sheets allocated to each of the destination printing apparatuses.

15. A print control method according to claim 14, wherein
the selected distribution method is a distribution method having the smallest maximum number of printed sheets among the multiple distribution methods.

16. A print control method according to claim 12 further comprising obtaining priority information used to specify a distribution method that is to be given priority among the multiple distribution methods,
wherein the selected distribution method is selected based on the evaluation results and the priority information.

17. A print control method according to claim 16, wherein
where two or more distribution methods exist for which the evaluation results are equal, a distribution method to which the priority is given is selected among the two or more distribution methods.

18. A print control method according to claim 16, wherein
the priority information is included in the received print job.

19. A print control method according to claim 14, wherein
the evaluation is performed taking into account a characteristic related to the printing speed of each of the destination printing apparatuses.

20. A computer program product for distributing a print job to multiple destination printing apparatuses, the computer program product comprising:
a computer readable medium; and
a computer program stored on the computer readable medium, the computer program comprising:
a first program code for receiving the print job;
a second program code for evaluating the amount of time required for printing requested by the received print job for multiple distribution methods;
a third program code for selecting a distribution method having shortest time required for printing from among the multiple distribution methods based on the evaluation results; and
a fourth program code for distributing the received print job using the selected distribution method.

21. A printing apparatus in which the printing controller according to claim 2 is installed.

22. A printing apparatus in which the printing controller according to claim 3 is installed.

23. A printing apparatus in which the printing controller according to claim 4 is installed.

24. A printing apparatus in which the printing controller according to claim 5 is installed.

25. A printing apparatus in which the printing controller according to claim 6 is installed.

26. A printing apparatus in which the printing controller according to claim 7 is installed.

27. A printing apparatus in which the printing controller according to claim 8 is installed.

28. A printing apparatus in which the printing controller according to claim 9 is installed.
